(19) United States
(12) Patent Application Publication
(10) Pub. No.: US 2003/0233473 A1
(43) Pub. Date: Dec. 18, 2003

(54) Method for configuring logical connections to a router in a data communication system

(75) Inventors: Julien Bonhomme, Nice (FR); Anne-Lise Conjeaud, Antibes (FR); Jean-Claude Dispensa, St Jeannet (FR); Arnaud Lund, Cagnes sur Mer (FR)

Correspondence Address: IBM CORPORATION, IPLAW IQ0A/40-3, 1701 NORTH STREET, ENDICOTT, NY, 13760, US

(73) Assignee: International Business Machines Corporation, Armonk, NY

(21) Appl. No.: 10/425,038

(22) Filed: Apr. 28, 2003

(30) Foreign Application Priority Data
May 7, 2002 (EP) 02368047.3

(51) Int. Cl. G06F 15/173

(52) U.S. Cl. 709/238

(57) ABSTRACT

A method of tracking the availability of a logical connection to a router in a data transmission system including a network, a plurality of customer servers, and at least two network access routers using Virtual Router Redundancy Protocol or the like to set up a primary interface router. The method is automatically achieved in each router by periodically tracking at least one logical connection between the primary interface router and a neighbor router connected to the network. Virtual Router Redundancy Protocol sets up one of the backup routers as primary interface router when the logical connection has failed.

### TECHNICAL FIELD

The present invention relates to configuring data transmission systems wherein several routers can be used for transferring data from a plurality of servers to a network, and relates in particular to a method of tracking the availability of a logical connection between a router and the network in such a data transmission system.

### BACKGROUND

Several routers may be used in a data transmission system for transferring data from a plurality of servers to a network such as the Internet. A router is adapted to receive on one interface the traffic from different servers. The use of a single router to route the traffic coming from the servers, however, creates a single point of failure in the network. To avoid this, a second router may act as a backup in case of failure of the primary router.

A traditional way to solve this problem is to use the Virtual Route Redundancy Protocol (VRRP), which was created to overcome problems due to the failure of a router in a network using static routing. VRRP allows the servers to see the redundant routers as a single virtual router. At any instant, only one router really owns the virtual router function, based on the availability of the router interfaces or on static priorities associated with them by configuration. The interface having the highest priority is the one elected to own the virtual router interface. The associated router acts as the virtual router until it fails or until another interface with a higher priority appears.

The mode of operation using the VRRP protocol is preferable where dynamic host configuration protocols such as DHCP are used. DHCP typically provides configuration for an end host IP address and a default gateway. However, this creates a single point of failure. Loss of the default router results in a catastrophic event isolating all end hosts that are unable to detect any alternate path that may be available. VRRP is designed to eliminate the single point of failure. It specifies an election protocol that dynamically assigns responsibility for a virtual router to one of the VRRP routers. The election process provides a dynamic failover in the forwarding responsibility should the master router become unavailable.

VRRP works well in case of the failure of the primary router or the interface of the router on which the protocol is exchanged. However, if the interface of the router to the backbone network fails, the primary router turns into a “black hole”. This is why many implementations of VRRP provide a tracked IP mechanism. In such a mechanism, the availability of the outgoing interface is tracked by the router. If it happens to fail, then the router will trigger the VRRP backup mechanism. The primary router becomes a secondary router, whereas one of the secondary routers becomes the primary router through which the traffic is transmitted to the network.

Unfortunately, tracking of the interface does not cover all cases where the primary router may become a black hole, such as when a primary router with a perfectly working interface loses its connection at the IP level or at a higher protocol level with a neighbor router.

### SUMMARY

Accordingly, an object of the invention is to extend the tracked IP mechanism in a router by tracking the availability of a logical connection to a neighbor router.

The invention includes a method of tracking the availability of a logical connection to a router in a data transmission system that includes a network, a plurality of customer servers and at least two network access routers. The network access routers use Virtual Router Redundancy Protocol (VRRP) or the like to set up, as primary interface router, the network access router which owns the primary interface to at least one customer server, and through which is established communication between a network user and the customer server. This method is automatically achieved in each router by periodically tracking at least one logical connection between the primary interface router and at least a neighbor router connected to the network. The Virtual Router Redundancy Protocol sets up one of the backup network access routers as primary interface router when the logical connection has failed.

### BRIEF DESCRIPTION OF THE DRAWINGS

The above and other objects, features and advantages of the invention will be better understood by reading the following more particular description of the invention in conjunction with the accompanying drawings wherein:

FIG. 1 is a block-diagram representing a data transmission system implementing the invention before the tracked logical connection has failed,

FIG. 2 is a block diagram representing a data transmission system implementing the invention after the tracked logical connection has failed, wherein the data path is through the backup router, and

FIG. 3 is a flowchart of an embodiment of the method according to the invention.

### DETAILED DESCRIPTION

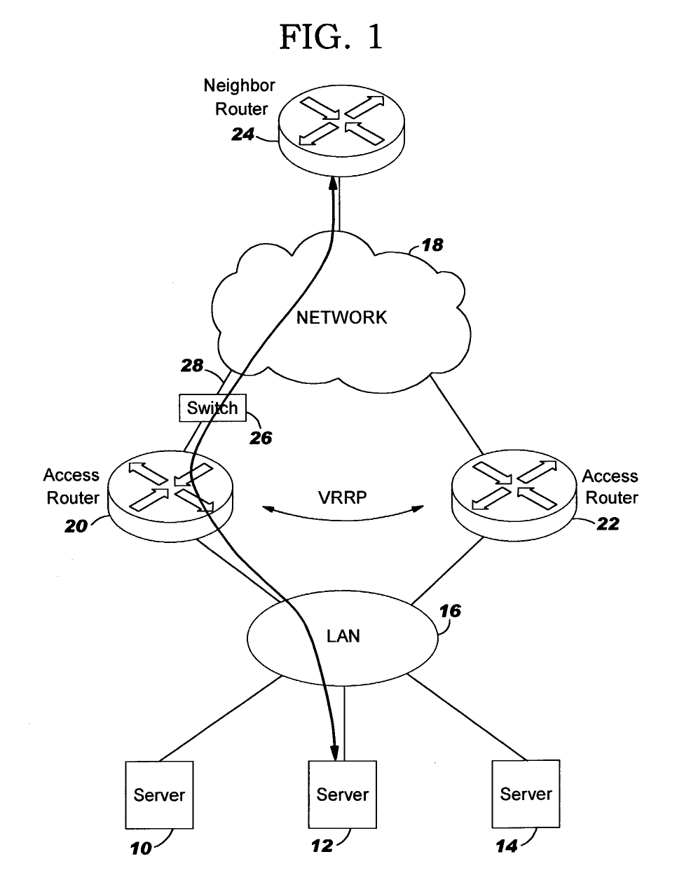

As shown in FIG. 1, a data transmission system wherein the method according to the invention may be used comprises a plurality of WEB servers 10, 12, 14 connected to a Local Area Network (LAN) 16. The LAN 16 is connected to a network 18 such as a Wide Area Network (WAN) by a set of routers such as routers 20 and 22. At any instant, one of the two routers 20 and 22 is the primary router, whereas the other one is a secondary router, by application of the VRRP protocol. Assuming that a communication is established between server 12 and a neighbor router 24 connected to the network 18, the data path is through router 20. Note that there is a continuous exchange of control data between router 20 and router 22 so that the VRRP protocol can detect failure of router 20, in order to trigger the virtual primary router from router 20 to router 22.

Assuming also that the two routers are provided with the VRRP backup IP mechanism, the VRRP protocol detects the availability of the outgoing interface of router 20 to the network 18. But, assuming that there is a switch 26 in the link connecting the router 20 to network 18, any failure of the part 28 of this link located after the switch 26 will not be detected by the VRRP protocol in router 20 if the method according to the invention is not used.

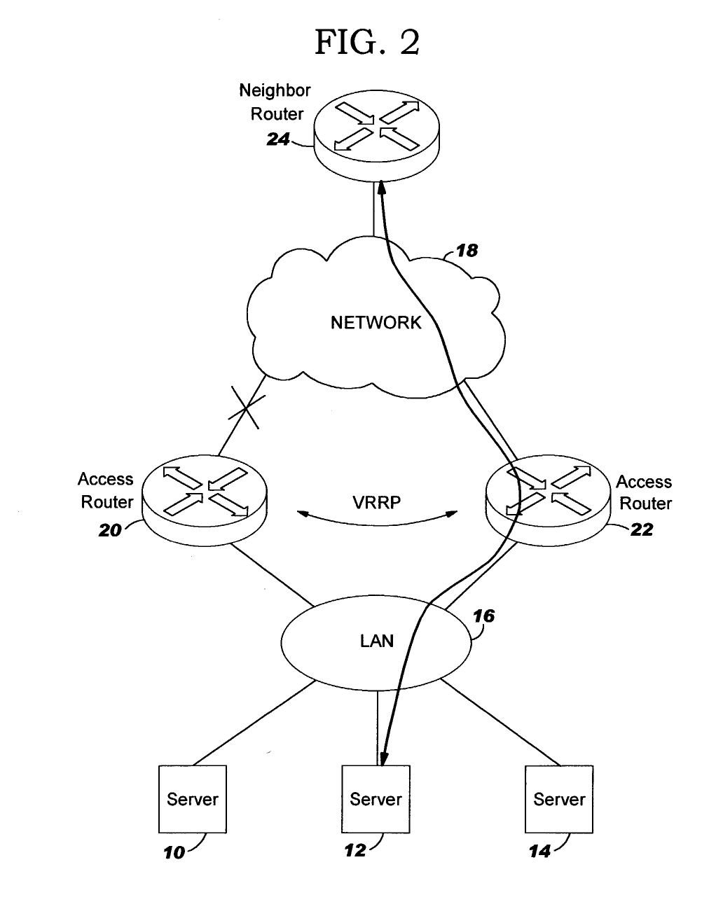

Now, if the method according to the invention as described below is used, any loss of the logical connection between router 20 and neighbor router 24 is detected. In such a case, which is illustrated in FIG. 2, the router 20 is no longer used as the primary interface router, and the communication between server 12 and the neighbor router 24 is established through router 22, which has now become the new primary interface router.

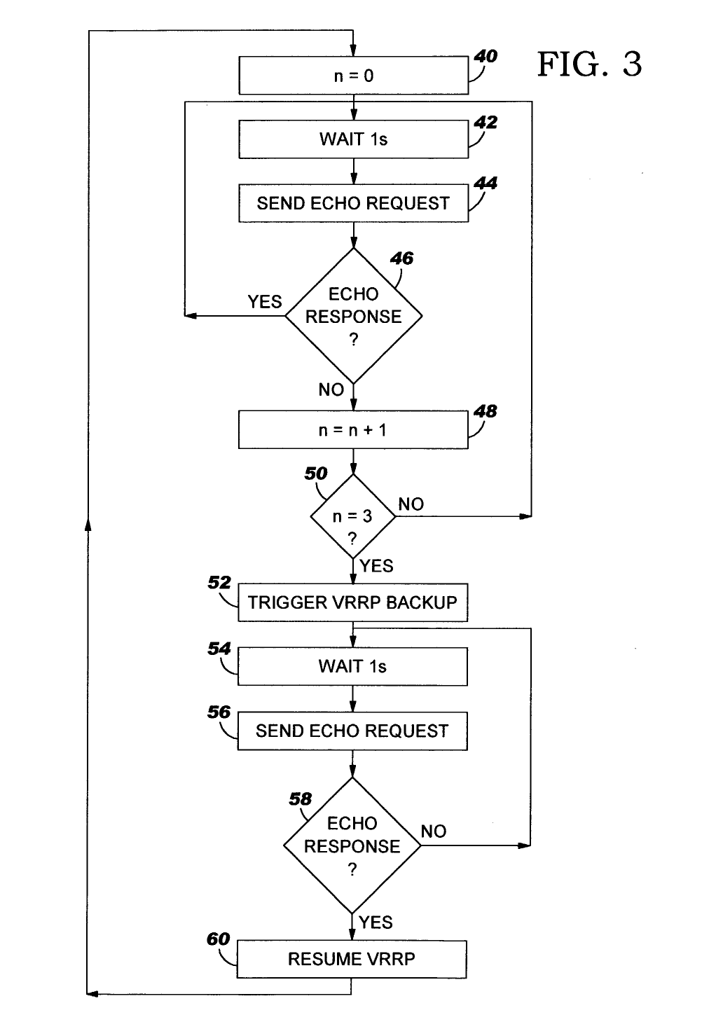

According to a preferred embodiment of the invention, the tracking of the logical connection to the neighbor router 24 includes periodically checking the reachability of the target address on the incoming interface of neighbor router 24. At the initialization of the method illustrated by the flow chart of FIG. 3, a variable n is set to 0 (step 40). Then, a timer is set up for one second (step 42), before an echo request message is sent from router 20 to neighbor router 24 (step 44). If a response message is received in response to the echo request message before a predetermined time out (step 46), this means that the logic connection is not lost, and a new echo request message is sent after waiting again for one second.

If there is no response to the echo request message, the variable n is set to n+1 (step 48), and a check is made to determine whether n=3 (step 50). If not, the process is looped back to the steps of waiting for one second (step 42) and sending a new echo request message (step 44).

When n=3 (step 50), meaning that no echo reply has been received three times in a row, it is presumed that the logical connection has been lost. In such a case, the VRRP mechanism is triggered in the same way as if the outgoing interface of router 20 were down (step 52).

Then, the timer is set up for one second (step 54) before an echo request message is again sent to the neighbor router 24 (step 56). If there is no response after a predetermined time out (step 58), meaning that the logical connection is still unavailable, the process of waiting for one second (step 54) and sending an echo request message (step 56) is performed again until the path through router 20 has been repaired. When a response is received before a predetermined time out, this means that the logical connection being checked has been restored. In such a case, the router resumes its VRRP activity as a primary router (step 60), and the whole process is started again.

In another embodiment of the invention, the router uses a dynamic protocol such as the Border Gateway Protocol (BGP) to learn from the neighbor router where it needs to route frames. In this situation, the loss of the BGP session with the neighbor router 24 causes the frames that should be transmitted from router 20 to be lost. Therefore, router 20 monitors periodically the status of the BGP session. If the status of the BGP session is different from “established”, this means that the router 20 is no longer receiving routes from the neighbor router 24. Router 20 will then trigger the VRRP backup mechanism allowing the data path to be established through router 22. Router 20 will remain in this state until the status of the BGP connection with router 22 again becomes “established”. In this case, router 20 will become the primary router again, and the situation will be back to the initial state.

Although the system which has been described includes only one neighbor router, and therefore only one connection from the VRRP primary router to the network, the router may have multiple connections to several neighbor routers of the network.

In such a case and depending on the importance of each connection in relation to the data flows crossing the VRRP primary router, it is possible to switch to a VRRP secondary router when some connections are lost or even as soon as any one of them is lost. To achieve this, each of the IP addresses or logical connections to the neighbor routers will be tracked independently in the same way as describe above. In addition to this, each tracked IP address or logical connection is assigned a weight represented by a number. The router adds up all numbers of the tracked connections that are operating properly. Then, the router will trigger the backup router only when this sum is below a predetermined configurable threshold.

We claim:

1. A method for configuring logical connections in a data communication system that includes a server and two network access routers, wherein one of the network access routers is the primary interface router for the server and the other network access router is a backup router for the server, said method comprising the steps of:
automatically testing availability of a logical connection between the primary interface router and a neighbor router; and
when the step of testing availability determines that the logical connection has become unavailable, connecting the server to the neighbor router through the backup router.

2. The method of claim 1, wherein the step of connecting the server to the neighbor router through the backup router is performed using Virtual Router Redundancy Protocol to set up the backup router as new primary interface router.

3. The method of claim 1, wherein the step of testing availability includes checking a status of Border Gateway Protocol, and the step of connecting is executed in response to a change of the status.

4. The method of claim 1, wherein the step of testing availability includes the steps of sending an echo request message to the neighbor router and determining whether a response to the echo request message is received from the neighbor router.

5. The method of claim 4, wherein the server is connected to the neighbor router through the backup router after the neighbor router fails to respond to three consecutive echo request messages according to the step of determining.

6. A method for configuring logical connections in a data communication system that includes a server and a plurality of network access routers, wherein one of the network access routers is the primary interface router for the server and the other network access routers are backup routers for the server, said method comprising the steps of:
automatically testing availability of a logical connection between the primary interface router and a neighbor router; and
when the step of testing availability determines that the logical connection has become unavailable, connecting the server to the neighbor router through the backup router that is least heavily loaded according to a sum of weights assigned to connections supported by the backup router.
